(19) United States
(12) Patent Application Publication
(10) Pub. No.: US 2025/0269713 A1
(43) Pub. Date: Aug. 28, 2025

(54) DEVICE FOR SEALING AN AIR INLET OF A FRONT FACE OF A MOTOR VEHICLE

(71) Applicant: VALEO SYSTEMES THERMIQUES, La Verriere (FR)

(72) Inventors: Victor Manuel MINERO RAMALES, La Verriere (FR); Frederic VACCA, La Verriere (FR); Karim ARAB, La Verriere (FR)

(73) Assignee: VALEO SYSTEMES THERMIQUES, La Verriere (FR)

(21) Appl. No.: 18/556,129

(22) PCT Filed: Apr. 20, 2022
(86) PCT No.: PCT/EP2022/060467

§ 371 Date: Oct. 19, 2023

(30) Foreign Application Priority Data
Apr. 22, 2021 (FR) FR2104227

(51) Int. Cl. B60K 11/08

(52) U.S. Cl. CPC B60K 11/085

(57) ABSTRACT

A device for sealing an air inlet of a motor vehicle, including a support frame with a front and rear faces, the support frame including a through-orifice with a sealing assembly with at least two complementary flaps, each of which is movable about a corresponding pivot axis between a sealing and an open positions, the device further including a system for synchronously opening the flaps having a suspended element arranged on the rear face of the support frame and movable between a position close to the support frame and a position remote from the support frame, the suspended element being connected to each of the flaps such that, in the close position, the flaps are in the sealing position and, in the remote position, the flaps are in the open position.

### TECHNICAL FIELD

The present invention relates to a shutter device, and more specifically a device for closing an air inlet of a front face of a motor vehicle.

### BACKGROUND OF THE INVENTION

The front faces of motor vehicles are generally made up of two main air inlets, referred to as the top route and the bottom route, separated by a bumper beam. The heat exchangers of the motor vehicle, such as for example the one used for the passenger compartment air conditioning and/or the one used for cooling the engine, are generally placed behind this bumper beam.

It is also known practice to arrange, in the path of air passing through the main air inlets, more generally the bottom route, a support frame comprising a multiplicity of flaps mounted pivotably about parallel axes and suitable for adopting a multiplicity of different angular positions, between an open position and a closing position, under the action of an appropriate controller. The various flaps generally comprise, at one of their ends, a lever arm connected to a shared connecting rod. This shared connecting rod is translated by an actuator and thus controls the synchronous opening and closing of the flaps.

A shutter device resembling a Venetian blind is thus obtained that makes it possible to adjust the flow rate of air passing through the air inlets and arriving at the heat exchangers. It is thus possible to optimize the effectiveness of these heat exchangers, depending on the requirements, by varying the amount of air they receive. In addition, at high speed, the flaps in the closing position make it possible to reduce the drag coefficient of the vehicle and thus improve the aerodynamics of said vehicle.

However, this type of shutter device can be unsuitable, in particular when the flaps are not arranged parallel to each other, for example due to the aesthetic requirements of the manufacturer. In this situation, it is important that the opening and closing of the flaps is synchronous, and this cannot be provided by a shared connecting rod connection when the flaps do not open parallel to each other.

One of the aims of the present invention is therefore to at least partially overcome the drawbacks of the prior art by proposing an improved shutter device allowing synchronous control of the opening and closing of the flaps, regardless of their arrangement within the support frame.

### BRIEF SUMMARY OF THE INVENTION

The present invention therefore relates to a device for closing an air inlet of a motor vehicle, said shutter device comprising a support frame comprising a front face, suitable for being exposed to an incoming air flow, and a rear face opposite the front face, said support frame comprising at least one through-orifice, each through-orifice comprising a shutter assembly comprising at least two complementary flaps that are each movable about a respective pivot axis between a closing position, in which the through-orifice is closed by complementarity of the at least two flaps, and an open position, in which the incoming air flow can pass through the through-orifice, the flaps opening so that they protrude from the rear face of the support frame in the open position,
the shutter device further comprising a system for synchronous opening of the flaps, said opening system comprising:
a suspended element arranged on the rear face of the support frame and movable between a position close to the support frame and a position distant from the support frame, said suspended element being connected to each of the flaps so that in the close position, the flaps are in the closing position, and in the distant position, the flaps are in the open position,
an actuation device configured to move the suspended element between the close position and the second, distant position.

According to one aspect of the invention, the pivot axis of the flaps of a shutter assembly are arranged in the same plane.

According to another aspect of the invention, within the same shutter assembly, at least two pivot axis of flaps are arranged on either side of the through-orifice.

According to another aspect of the invention, within the same shutter assembly, the pivot axis of the flaps are arranged on the periphery of the through-orifice.

According to another aspect of the invention, within the same shutter assembly, the free edge of each flap that is distal to the pivot axis covers part of a central zone of the through- orifice in the closing position.

According to another aspect of the invention, the system for opening the flaps comprises at least one guide device for guiding the translation of the suspended element between its position close to and its position distant from the support frame.

According to another aspect of the invention, the guide device comprises:
a hollow member arranged on the support frame, the hollow of said member extending along an axis parallel to the movement of the suspended element, and
a guide rod inserted into the hollow member so that it can slide in said hollow member and one end of which is connected to the suspended element.

According to another aspect of the invention, the connection between the suspended element and a flap comprises a connecting rod fastened at a first end to the flap by a pivot connection and fastened at a second end to the suspended element by another pivot connection.

According to another aspect of the invention, the actuation device comprises at least one linear actuator.

According to another aspect of the invention, the actuation device comprises:
at least a first shaft arranged on the rear face of the support frame on a first side of the at least one shutter assembly, said at least one first shaft being connected to an actuator so that it can be rotated,
at least a second shaft arranged on the rear face of the support frame on a second side of the at least one shutter assembly, opposite the first side,
at least one transmitter for transmitting the rotation of the first shaft to the second shaft,
at least one converter for converting the rotation of the first and second shafts into the translation of the suspended element.

According to another aspect of the invention, the transmitter for transmitting the rotation of the first shaft to the second shaft comprises a first lever arm borne by the first shaft and a second lever arm borne by the second shaft, the ends of the first and second lever arms being connected to each other by a connecting rod.

According to another aspect of the invention, the transmitter for transmitting the rotation of the first shaft to the second shaft comprise a notched belt connecting the first and second shafts.

According to another aspect of the invention, the transmitter for transmitting the rotation of the first shaft to the second shaft comprises a pinion borne by each of the first and second shafts, said pinions being connected by a drive chain.

According to another aspect of the invention, the transmitter for transmitting the rotation of the first shaft (9a) to the second shaft are arranged so that they are concealed behind a structural element of the support frame.

According to another aspect of the invention, the converter for converting the rotation of the first and second shafts into the translation of the suspended element comprise:
a crank borne by one of the first and second shafts,
a connecting member connected at one of its ends to the suspended element and connected to the crank at its opposite end.

According to another aspect of the invention, the connecting member is a connecting rod comprising an articulated connection with the crank and an articulated connection with the structural element.

According to another aspect of the invention, the connecting member is a sliding pivot connection between the crank and the end of a rod of the suspended element, said end of the rod comprising a slider extending in a plane perpendicular to the axis of rotation of the shaft.

According to another aspect of the invention, the suspended element is perforated in line with the through-orifices so as to allow the circulation of an air flow.

According to another aspect of the invention, the support frame comprises a plurality of through-orifices in the shape of a regular polygon, the shutter assemblies comprising one triangular flap per side of said through-orifices.

According to another aspect of the invention, the support frame comprises, within the at least one through-orifice, a grid on which the edges of the flaps rest in the closing position.

### BRIEF DESCRIPTION OF THE DRAWINGS

Further features and advantages of the invention will become more clearly apparent on reading the following description, which is given by way of non-limiting illustrative example, and from the appended drawings, in which:

FIG. 1 shows a schematic perspective depiction of the front face of a shutter device in the closing position,

FIG. 2 shows a schematic perspective depiction of the rear face of a shutter device in the closing position,

FIG. 3 shows a schematic perspective depiction of a shutter assembly of a through-orifice of the support frame,

FIG. 4 shows a schematic perspective depiction of the rear face of a shutter device in the closing position with a system for synchronous opening of the flaps,

FIG. 5 shows a schematic cross-sectional side view of the system for synchronous opening of the flaps with the flaps in the closing position,

FIG. 6 shows a schematic cross-sectional side view of the system for synchronous opening of the flaps with the flaps in the open position,

FIG. 7 shows a schematic cross-sectional side view of a transmitter for transmitting the rotation of the first shaft to the second shaft in a first position,

FIG. 8 shows a schematic cross-sectional side view of a transmitter for transmitting the rotation of the first shaft to the second shaft in a second position,

FIG. 9 shows a schematic perspective depiction of a crank of a shaft,

FIG. 10 shows a schematic cross-sectional side view of a converter in a first position according to a first embodiment,

FIG. 11 shows a schematic cross-sectional side view of a converter in a second position according to the first embodiment,

FIG. 12 shows a schematic cross-sectional side view of a converter in a first position according to a second embodiment, and

FIG. 13 shows a schematic cross-sectional side view of the converter in a second position according to the second embodiment

### DETAILED DESCRIPTION OF THE INVENTION

In the various figures, identical elements bear the same reference signs.

The following embodiments are examples. Although the description refers to one or more embodiments, this does not necessarily mean that each reference relates to the same embodiment, or that the features apply only to one single embodiment. Individual features of different embodiments can also be combined or interchanged to provide other embodiments.

In the present description, certain elements or parameters can be given ordinal numbers such as, for example, first element or second element, as well as first parameter and second parameter or even first criterion and second criterion, etc. In this case, this ordinal numbering is simply to differentiate between and denote elements or parameters or criteria that are similar but not identical. This ordinal numbering does not imply any priority of one element, parameter or criterion over another and such numbering can easily be interchanged without departing from the scope of the present description. Likewise, this ordinal numbering does not imply any chronological order, for example, in assessing any given criteria.

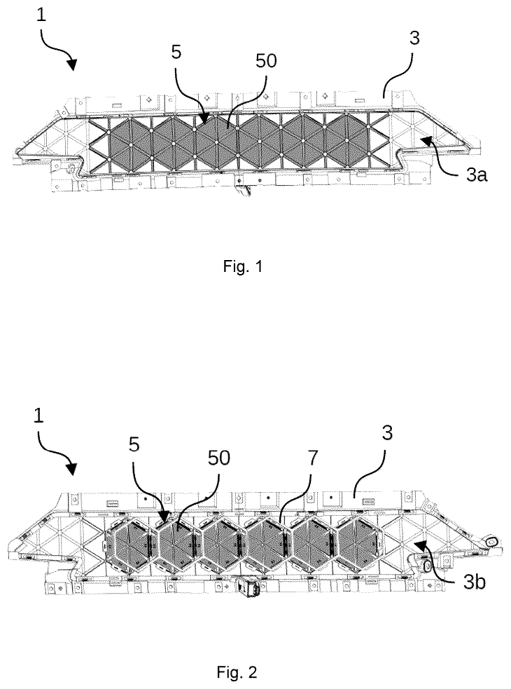

FIGS. 1 and 2 show a shutter device 1 for closing or opening an air inlet of a motor vehicle. Such a shutter device 1 is generally arranged on the front face of the motor vehicle and makes it possible to control an incoming air flow, in particular destined for heat exchangers such as radiators and/or evaporator-condensers. The shutter device 1 also makes it possible to orient the incoming air flow in a desired direction, for example in order to orient it toward the heat exchangers. This shutter device 1 comprises a support frame 3 comprising a front face 3a (visible in FIG. 1), suitable for being exposed to the incoming air flow, and a rear face 3b (visible in FIG. 2) opposite the front face 3a. The front face 3a is in particular suitable for facing an incoming air flow, for example being oriented toward the front of the motor vehicle when mounted. The rear face 3b is suitable for facing the inside of the motor vehicle when mounted, for example facing one or more heat exchangers.

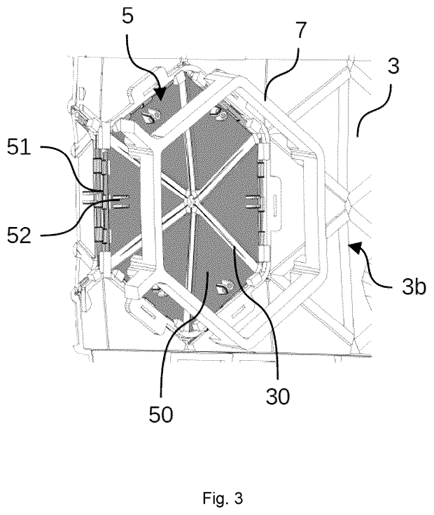

The support frame 3 comprises at least one through-orifice so that the incoming air flow passes through the shutter device. Each through-orifice comprises a shutter assembly 5 comprising at least two complementary flaps 50. The flaps 50 are each movable about a respective pivot axis 51 (visible in FIG. 3) between a closing position, in which the through-orifice is closed by complementarity of the at least two flaps 50, and an open position in which the incoming air flow can pass through the through-orifice. More particularly, the flaps 50 open so that they protrude from the rear face 3b of the support frame 3 in the open position.

In the example illustrated in FIGS. 1 and 2, the support frame 3 comprises a plurality of through-orifices, here six, each comprising its own shutter assembly 5. In FIGS. 1 and 2, the through-orifices are positioned edge-to-edge. However, it is entirely possible to envisage through-orifices arranged apart from each other on the support frame 3.

As shown in more detail in FIG. 3, the pivot axis 51 of the flaps 50 of a shutter device 5 can more particularly be arranged in the same plane. Within a single shutter assembly 5, at least two pivot axis 51 of flaps 50 can in particular be arranged on either side of the through-orifice. In addition, the pivot axis 51 of the flaps 50 can be arranged on the periphery of the through-orifice. The free edge of each flap 50, which is distal to the pivot axis 51, can cover part of a central zone of the through-orifice in the closing position. The support frame 3 can also comprise, within the at least one through-orifice, a grid 30 on which the edges of the flaps 50 rest in the closing position.

In the example illustrated in FIGS. 1 to 3, the through-orifice is in the shape of a regular polygon, more particularly here a hexagon. The shutter assemblies 5 then comprise one triangular flap 50 per side of said through-orifices.

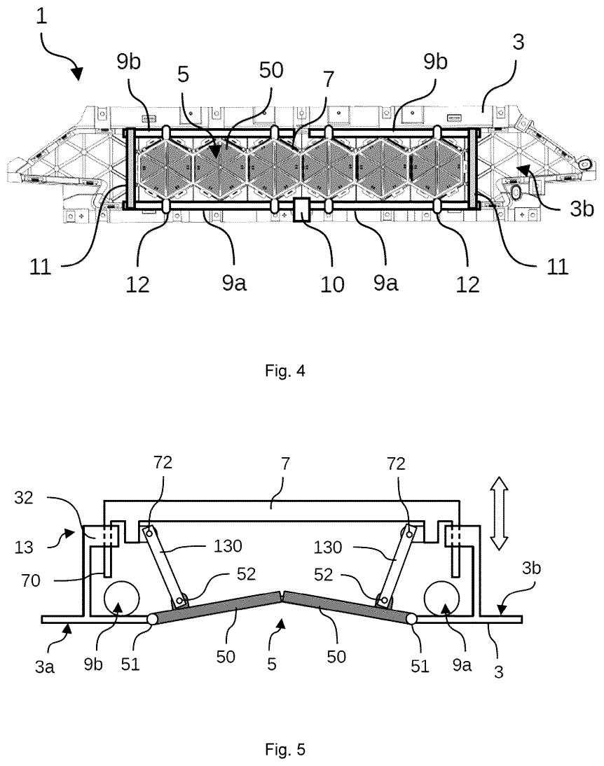

The shutter device 1 further comprising a system for synchronous opening of the flaps 50 illustrated in FIG. 4. This opening system firstly comprises a suspended element 7 arranged on the rear face 3b of the support frame 3. Here, suspended is given to mean that the element 7 is kept at a distance from the rear face 3b of the support frame 3 and is movable relative to the support frame 3. The suspended element 7 is more particularly perforated in line with the through-orifices so as to allow the circulation of an air flow.

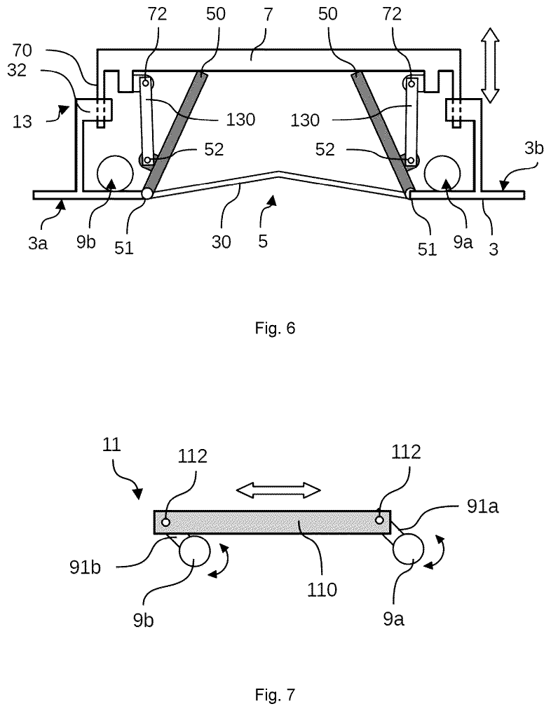

This suspended element 7 is in particular movable between a position close to the support frame 3 and a second position distant from the support frame 3. The suspended element 7 is connected to each of the flaps 50 so that in the close position, the flaps 50 are in the closing position (see FIG. 5), and in the distant position, the flaps 50 are in the open position (see FIG. 6).

In order to switch from one position to another, the suspended element 7 can in particular perform a straight translation perpendicular to the plane defined by the support frame 3. In order to ensure a straight translation, the system for opening the flaps 50 can in particular comprise at least one guide device 13 for guiding the translation of the suspended element 7 between its position close to and its position distant from the support frame 3. The guide device 13 can in particular connect the suspended element 7 to the support frame 3 and be configured so that it gives the suspended element 7 just one degree of freedom of movement between its position close to and its position distant from the support frame 3. The system for opening the flaps can in particular comprise a plurality of guide devices 13 arranged evenly around the suspended element 7 in order to ensure uniform guidance of said suspended element 7.

This guide device 13 can in particular comprise:
a hollow member 32 arranged on the support frame 3, the hollow of said member 32 extending along an axis parallel to the movement of the suspended element 7, and
a guide rod 70 inserted into the hollow member 32 so that it can slide in said hollow cylinder 32 and one end of which is connected to the suspended element 7.

The guide rod 70 can for example be integrally formed with the suspended element 7. Another possibility is that the guide rod 70 is an add-on part fastened to the suspended element 7. The hollow of the hollow member 32 and the guide rod 70 can in particular have complementary shapes. For example, they can both be cylinders, or they can both have a complementary polygonal cross-section.

As illustrated in FIGS. 5 and 6, the connection between the suspended element 7 and a flap 50 can in particular comprise a connecting rod 130 fastened at a first end to the flap 50 by a pivot connection 52 and fastened at a second end to the suspended element 7 by another pivot connection 72. This pivot connections 52, 72 pivot more particularly about two axes parallel to the pivot axis 51 of the flap 50. The use of a rigid connecting rod 130 and pivot connections 52, 72 enables direct transmission of the forces and thus, when the suspended element 7 is translated to its distant position (FIG. 6), it pulls the flaps 50, conveying them to the open position and thus opening up the through-orifice. When the suspended element 7 is translated to its close position (FIG. 5), it pushes the flaps 50, conveying them to the closing position of the through-orifice. In the closing position of the flaps 50, the suspended element 7 and the connecting rod 130 hold the flaps 50 in the closing position and prevent them from opening under the force of the wind or any other force arriving on the front face 3a of the support frame 3.

The system for synchronous opening of the flaps 50 also comprises an actuation device configured to move the suspended element 7 from one position to another. According to a first variant, not illustrated, the shutter device 1 can comprise a linear actuator arranged on the support frame 3 and more particularly its rear face 3b, and directly connected to the suspended element 7 so that it imparts its translation thereto.

According to a second variant illustrated in FIG. 4, the actuation device can comprise at least one first shaft 9a arranged on the rear face 3b of the support frame 3. This first shaft 9a is arranged on a first side of the at least one shutter assembly 5. This first shaft 9a is connected to an actuator 10 so that it can be rotated. This rotation can for example be of the order of 90°. In the example illustrated in FIG. 4, the actuation device is provided with two first shafts 9a arranged on either side of an actuator 10 in a central position on the support frame 3. However, it is entirely possible to envisage for example a plurality of actuators 10 arranged at the end of each first shaft 9a. Another possibility is to have just one first shaft 9a extending over the entire width of the support frame 3 and having a single actuator 10 connected to one of its ends.

The actuation device further comprises at least one second shaft 9b arranged on the rear face 3b of the support frame 3 on a second side of the at least one shutter assembly 5, opposite the first side. The first shafts 9a are connected to the second shaft 9b by at least one transmitter 11 for transmitting the rotation of the first shaft 9a to the second shaft 9b. In the example illustrated in FIG. 4, the actuation device comprises two second shafts 9b. Each second shaft 9b is connected to a first shaft 9a by dedicated transmitter 11. An embodiment can also be envisaged in which a plurality of transmitter 11 connect a first shaft 9a and a second shaft 9b. Increasing the number of transmitter 11 enables in particular satisfactory transmission of the rotation and also makes it possible to spread the forces in order to limit the deformation stresses on the shafts 9a, 9b. The transmitter 11 can in particular transmit the rotation of the first shaft 9a to the second shaft 9b in both a clockwise direction and an anti-clockwise direction.

The transmitter 11 for transmitting the rotation of a first shaft 9a to a second shaft 9b are preferably arranged so that they are concealed behind a structural element of the support frame 3. In the example in FIG. 4, the transmitter 11 are arranged at one end of the first and second shafts 9a, 9b, behind the support frame 3. It is however entirely possible to envisage an embodiment in which the transmitter 11 pass between two through-orifices or above a grid 30 of a through-orifice. This thus makes it possible for the transmitter 11 not to be visible from the front face 3a of the support frame 3.

According to a first variant, not illustrated, the transmitter 11 for transmitting the rotation of the first shaft 9a to the second shaft 9b can comprise a notched belt connecting the first and second shafts 9a, 9b. According to a second variant, also not illustrated, the transmitter 11 for transmitting the rotation of the first shaft 9a to the second shaft 9b can comprise a pinion borne by each of the first and second shafts 9a, 9b, said pinions being connected by a drive chain.

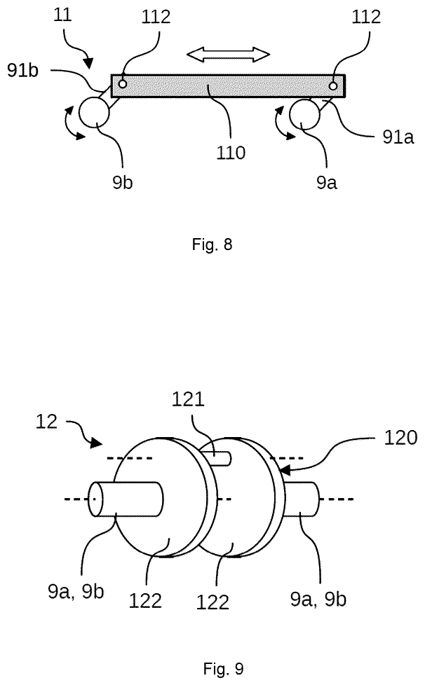

According to a third variant illustrated in FIGS. 7 and 8, the transmitter 11 for transmitting the rotation of the first shaft 9a to the second shaft 9b comprises a first lever arm 91a borne by the first shaft 9a and a second lever arm 91b borne by the second shaft 9b. The ends of the first and second lever arms 91a, 91b are connected to each other by a connecting rod 112. This connecting rod 112 comprises in particular pivot connections 112 with the first and second lever arms 91a, 91b. The lever arms 91a, 91b can in particular be integrally formed with their respective shafts 9a, 9b. The shafts 9a, 9b with their lever arms 91a, 91b can for example be produced by injection molding. According to one embodiment, not shown, the lever arms 91a, 92b can take the form of disks that are concentric with the shaft 9a, 9b and comprise an offset pin or orifice in order to ensure the pivot connection with the connecting rod 112.

With reference to FIG. 4, the actuation device also comprises at least one converter 12 for converting the rotation of the first and second shafts 9a, 9b into the translation of the suspended element 7. In the example illustrated in FIG. 4, the actuation device comprises a plurality of converter 12 evenly distributed on the various shafts 9a, 9b. Having a plurality of converter 12 enables uniform pushing and pulling of the suspended element 7 and limits the twisting forces and the risk of jamming. The various converter 12 are also synchronous with each other so that they exert uniform pushing or pulling on the suspended element 7.

The converter 12 are described in greater detail in FIGS. 9, 10, 11, 12 and 13. The converter 12 for converting the rotation of the first and second shafts 9a, 9b into the translation of the suspended element 7 firstly comprise a crank 120 borne by one of the first and second shafts 9a, 9b. Here, crank 120 is given to mean a pin 121 parallel to the axis of rotation of the first or second shaft 9a, 9b and offset relative thereto. The pin 121 and the first or second shaft 9a, 9b are connected by at least one lever arm 122. In the example illustrated in FIG. 9, the lever arm 122 is a disk concentric with the axis of rotation of the first or second shaft 9a, 9b. Using a disk as a lever arm 122 enables improved distribution of mass, in particular during rotation. Still according to the example illustrated in FIG. 9, the crank 120 comprises two lever arms 122. This makes it possible to clear the axis of rotation of the first or second shaft 9a, 9b while ensuring continuity of rotation between two portions of shaft 9a, 9b separated by the crank 120. However, it is entirely possible to envisage an embodiment in which a U-shaped crank 120 a similar shape to a crankshaft is used, or comprising a lever arm in a form other than a disk.

In order to ensure synchronous conversion and transmission to the suspended element 7, the plane connecting the pin 121 to the axis of rotation of the first or second shaft 9a, 9b is the same for all of the cranks 120 on the same shaft 9a, 9b. The cranks 120 of the first shaft 9a are arranged in a plane parallel to those of the second shaft 9b, again to ensure satisfactory synchrony.

The converter 12 for converting the rotation of the first and second shafts 9a, 9b into the translation of the suspended element 7 further comprise a connecting member connected at one of its ends to the structural element 7 and connected to the crank 120 at its opposite end.

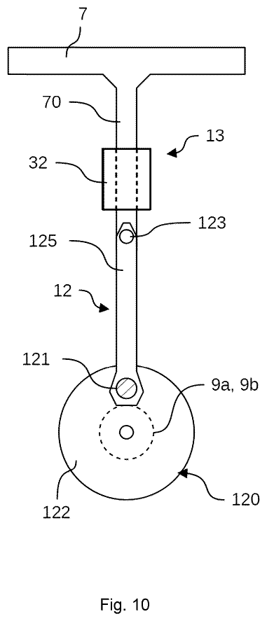

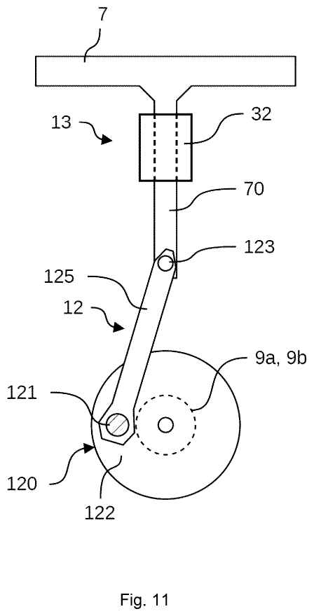

According to a first embodiment illustrated in FIGS. 10 and 11, the connecting member can be a connecting rod 125 comprising an articulated connection with the crank 120 and an articulated connection 123 with the suspended element 7. The articulated connection between the connecting rod 125 and the crank 120 is more particularly a pivot connection about the pin 121 of said crank 120. The articulated connection 123 between the connecting rod 125 and the suspended element 7 can also be a pivot connection pivoting about an axis parallel to the axis of rotation of the shaft 9a, 9b. In the example illustrated in FIGS. 10 and 11, this articulated connection 123 is produced at the end of the guide rod 70 of the suspended element 7. It is however entirely possible to envisage a variant, not illustrated, in which the articulated connection 123 is produced elsewhere on the suspended element 7.

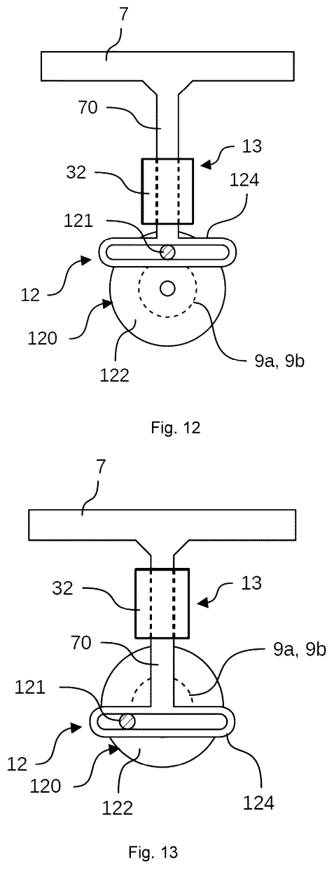

According to a second embodiment illustrated in FIGS. 12 and 13, the connecting member is a sliding pivot connection between the crank 120 and the end of the rod 70 of the suspended element 7. The end of the rod 70 comprises a slider 124 extending in a plane perpendicular to the axis of rotation of the shaft 9a, 9b, in which the pin 121 of the crank 120 can slide and rotate. Preferably, the rod 70 can be the same rod 70 of the suspended element 7 used for the guide device 13.

It can thus be clearly seen that, due to the presence of the suspended element 7, the shutter device 1 enables synchronous opening and closing of all of the flaps 50 regardless of their arrangement on the support frame 3.

What is claimed is:

1. A shutter device for an air inlet of a motor vehicle, comprising a support frame including a front, suitable for being exposed to an incoming air flow, and a rear face opposite the front face, said support frame including at least one through-orifice, with at least one shutter assembly including at least two complementary flaps that are each movable about a respective pivot axis between a closing position, in which the at least one through-orifice is closed by complementarity of the at least two complementary flaps, and an open position, in which the incoming air flow can pass through the at least one through-orifice, the at least two complementary flaps opening so that they protrude from the rear face of the support frame in the open position, the shutter device further comprising an opening system for synchronous opening of the at least two complementary flaps, said opening system including:
a suspended element arranged on the rear face of the support frame and movable between a position close to the support frame and a position distant from the support frame, said suspended element being connected to each of the at least two complementary flaps so that in the close position, the at least two complementary flaps are in the closing position, and in the distant position, the at least two complementary flaps are in the open position, and
an actuation device configured to move the suspended element between the close position and the second, distant position.

2. The shutter device as claimed in claim 1, wherein the opening system includes at least one guide device for guiding the translation of the suspended element between its position close to and its position distant from the support frame.

3. The shutter device as claimed claim 2, wherein the at least one guide device includes:
a hollow member arranged on the support frame, the hollowness of said member extending along an axis parallel to the movement of the suspended element, and
a guide rod inserted into the hollow member so that it can slide in said hollow member and that has one end of which is connected to the suspended element.

4. The shutter device as claimed in claim 1, wherein the connection between the suspended element and a flap of the at least two complementary flaps includes a connecting rod fastened at a first end to the flap of the at least two complementary by a pivot connection and fastened at a second end to the suspended element by another pivot connection.

5. The shutter device as claimed in claim 1, wherein the actuation device includes:
at least one first shaft arranged on the rear face of the support frame on a first side of the at least one shutter assembly, said at least one first shaft being connected to an actuator so that it can be rotated,
at least one second shaft arranged on the rear face of the support frame on a second side of the at least one shutter assembly, opposite the first side,
at least one transmitter for transmitting the rotation of the at least one first shaft to the at least one second shaft,
at least one converter for converting the rotation of the at least one first and the at least one second shafts into the translation of the suspended element.

6. The shutter device as claimed in claim 5, wherein the at least one transmitter for transmitting the rotation of the at least one first shaft to the at least one second shaft includes a first lever arm borne by the at least one first shaft and a second lever arm borne by the at least one second shaft, the ends of the first and second lever arms being connected to each other by a connecting rod.

7. The shutter device as claimed in claim 5, wherein the at least one converter for converting the rotation of the at least one first and at least one second shafts into the translation of the suspended element include:
a crank borne by one of the at least one first and the at least one second shafts,
a connecting member connected at one of its ends to the suspended element and connected to the crank at its opposite end.

8. The shutter device as claimed in claim 7, wherein the connecting member is a connecting rod including an articulated connection with the crank and an articulated connection with the structural element.

9. The shutter device as claimed in claim 7, wherein the opening system includes at least one guide device for guiding the translation of the suspended element between its position close to and its position distant from the support frame, wherein the at least one guide device includes:
a hollow member arranged on the support frame, the hollowness of said member extending along an axis parallel to the movement of the suspended element, and
a guide rod inserted into the hollow member so that it can slide in said hollow member and that has one end of which is connected to the suspended element
wherein the connecting member is a sliding pivot connection between the crank and the end of a red the guide rod of the suspended element, said end of the guide rod including a slider extending in a plane perpendicular to the axis of rotation of the shaft.

10. The shutter device as claimed in claim 1, wherein the support frame includes a plurality of through-orifices in the shape of a regular polygon, with respective shutter assemblies including one flap of the at least two complementary flaps, in a shape of a triangle, per side of said through-orifices.
